(19) United States
(12) Patent Application Publication
(10) Pub. No.: US 2017/0224572 A1
(43) Pub. Date: Aug. 10, 2017

(54) DEVICE FOR PASSIVE THERAPEUTIC EXERCISE

(71) Applicants: Simona TOLAROVÁ, Minneapolis, MN (US); Eduard ZELEZNY, Prague 4 (CZ)

(72) Inventor: Eduard ZELEZNY, Prague (CZ)

(21) Appl. No.: 15/501,803

(22) PCT Filed: Aug. 5, 2015
(86) PCT No.: PCT/CZ2015/000086

§ 371 Date: Feb. 3, 2017

(30) Foreign Application Priority Data
Aug. 6, 2014 (CZ) PV 2014-533

(51) Int. Cl. A61H 1/02; A63B 22/16

(52) U.S. Cl. CPC A61H 1/02; A63B 22/16; A61H 2201/164; A61H 2201/1678; A61H 2201/123; A63B 2022/0097

(57) ABSTRACT

A device for passive therapeutic exercise comprises at least one pedal for supporting a foot during a swivelling motion of the foot, the pedal being pivotally mounted on a shaft, the pedal arranged on a side of a drive housing on a revolving shaft extending from the side wall of the drive housing, the revolving shaft coupled with a drive mechanism arranged in the drive housing to create a forced swinging movement of the pedal around an axis of the shaft, whereas the axis of swinging movement of the pedal is arranged under the pedal adjacent to the perpendicular projection of the ankle joint to the pedal, whereas the drive housing may be provided with outriggers to adjust the inclination of the drive housing towards the base, and a mechanism to switch operations on and off, and regulate the size of range and speed of the pedal swinging movement.

### FIELD OF TECHNOLOGY

The invention relates to a device for passive therapeutic exercise, especially for plantar and dorsal flexions of lower limbs, which comprises at least one pedal for swivelling motion of the foot, pivotally mounted on the shaft.

### CURRENT STATE OF TECHNOLOGY

In the civilized world of today a deep vein thrombosis becomes a new epidemic, which means that blood clots, thrombi, are formed in deep veins in the thigh and particularly in the popliteal part of the leg. In many cases, this situation results in serious life threatening complication, pulmonary embolism, in which thrombi penetrate with the blood to the lungs, where they clog small arteries, and thereby prevent the blood flow and oxygenation. The reason for thrombus formation is the lack of exercise by people with predominantly sedentary lifestyle. When moving the lower limbs muscles pump blood in the veins to the heart, and unless these muscles are in motion, blood circulation in the extremities slows down, which creates a major risk factor for thrombus formation.

Research conducted in people at risk of venous thromboembolism showed that the current use of electro-mechanical devices that cause muscle contraction significantly reduces the risk of DVT. These devices stimulate leg and thigh muscles and thus accelerate the venous blood flow, which leads to a better dispersion of activated blood components and dissolution of small thrombi. Such devices are mainly used for patients lying after injury.

However, not only lying patients but a far greater number of healthy people, who sit at work, such as IT workers, office workers, computer gamers, etc., are at risk to health and life due to the formation of clots n deep veins, and predominantly in the popliteal part of legs and thighs. It was found out that every hour of sitting, which decreases blood flow to the rear side of the knee, increases the risk of thrombus formation by ten percent.

A wide range of devices with pedals powered by pedalling or electrically are known, which cause movement of the legs. The movement of the leg on a pedal is dual; first, primary, rotating around the axis of rotation of the crank bearing pedals and secondary, rocking movement around a pivot axis of the pedal crank. However, persons sitting at work hardly use these devices, partly because the vertical movement of the leg occupies a greater height that the height of the worktop and party because movement of the leg is transferred to the upper body thus preventing work by hands, e.g. with a keyboard and a mouse.

Persons who work mainly in a sitting position, such as IT staff, administrative works, cashiers in supermarkets, are due to immobility of the lower limbs threatened not only by atrophy of muscles but especially by blood clothing resulting in formation of pulmonary embolism or heart attacks. To avoid these problems it is necessary to exercise the legs by feet motion, i.e. plantar and dorsal flexions, always after one or two hours of sitting.

Various devices are known to simulate the movement of the leg in order to exercise the muscles. They support the leg by a pedal that defines the movement. Currently known devices have pedals performing rotary motion similarly as the bicycle pedals. Some are driven by an electric motor, others by pedalling. A disadvantage of these known devices is on the one hand the range of motion of a pedal, which is so large that the exercise cannot take place under the desk, so these devices cannot be used where they are needed, i.e. during sedentary work, and on the other hand, even with such a large movement of the leg the needed plantar and dorsal flexions are very small.

The literature also mentions a device, which sets muscles of the leg in motion by electric shocks with electrodes attached to the calf and thigh, while this motion is regulated and measured by a rocking pedal that uses spring to create resistance of the muscle movement. These shocks are achieved and controlled by switch-boards placed near the leg. The disadvantage of this and other know devices is that they cannot be used where they are needed, i.e. in sedentary work, since it is impossible for a working person to expose himself/herself to electric shocks at regular intervals and always strip for this purpose and fasten electrodes to the legs or even wear them for the whole working hours.

### SUMMARY OF THE INVENTION

The passive therapeutic device comprising at least one pedal for swivelling motion of a foot the pedal pivotally mounted on the shaft removes the said disadvantages of the current state of technology and meets the object of invention. According to the invention the pedal is located on the side of a drive housing on a rotating shaft extending from the side wall of the drive housing and coupled with a drive mechanism to create a forced movement of the pedal around the shaft axis. Preferably, the pedal swinging axis can be arranged adjacently to the perpendicular projection of the ankle joint to the pedal. The shaft axis may be advantageously arranged perpendicularly to the longitudinal axis of the pedal movable along a circular arc centred on the ankle joint. Preferably the drive housing may be provided with outriggers to adjust the inclination of the drive housing towards the base. The device for passive therapeutic exercise may advantageously include a mechanism to switch operations on and off as well as to regulate the size of range and speed of the pedal swinging.

The inventive device is based on rigorous and widely cited study that demonstrates that passive, i.e. externally controlled movement of feet determined by plantar and dorsal flexions significantly prevent the incidents of thrombosis and related complications. It was proved that stimulation of leg muscles, which pump blood, does not require any pedalling force, however only movement but not the vertical movement of the lower leg but only the rocking movement of the foot, i. e. plantar and dorsal flexions as a primary motion. The inventive device used by a seated person best stimulates natural gait, in which leg muscles pump enough blood and thereby prevent formation of life-threatening blood clogs without disturbing the user from focusing on work.

The inventive device consists of a housing and one or two pedals and it is arranged so that the pedals in a form of plates with dimensions corresponding to the dimensions of the feet are placed with the swing towards the housing. To drive the pedals the device is provided with a drive mechanism, in particular electric motor, connected with the pedals via kinetic mechanism arranged in the housing of the device. The swing angle is between 0° and 50°. The angle between plantar and dorsal flections shall be split by moving the device closer or further from a seated person. In order to split the angle between the plantar and dorsal flexions the device is provided at its ends with height-adjustable supports. Pedal swinging axis is located closer to the heel end of the pedal, in particular in one quarter of the length of the pedal so as it is approximately below the ankle joint. The device is further equipped with a mechanism for switching the activities on and off as well as for regulation of the size of the range and speed of the pedals rocking. Buttons to start and end the activities and to control the time and speed of swinging are arranged on the housing of the device and/or on a separate remote control. The remote control can be adapted for connection to a computer.

The advantage of the device is that it achieves the required plantar and dorsal flexions without affecting the upper torso, while it can be placed under a working desk and operated during sedentary work.

### Brief Description Of Drawings

### BRIEF DESCRIPTION OF DRAWINGS

The inventive device is explained in the drawings, in which

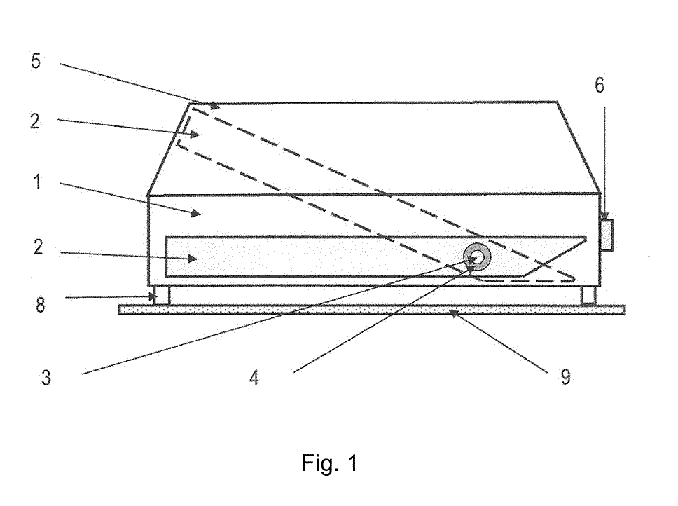

FIG. 1 is a side perspective view of the device

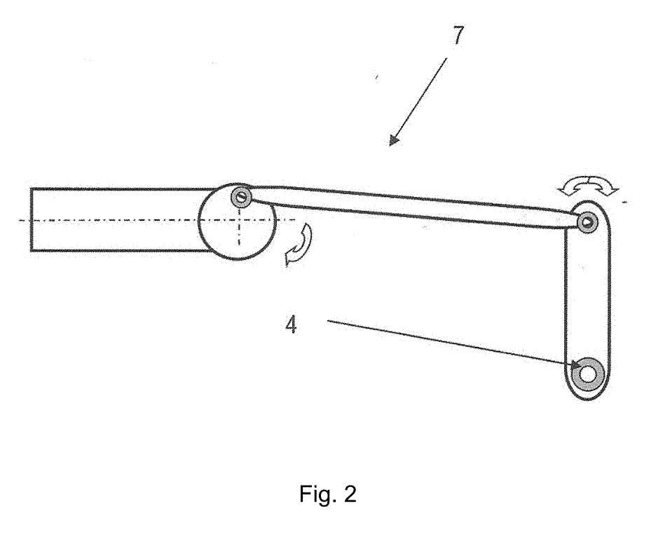

FIG. 2 is a diagram of a drive mechanism

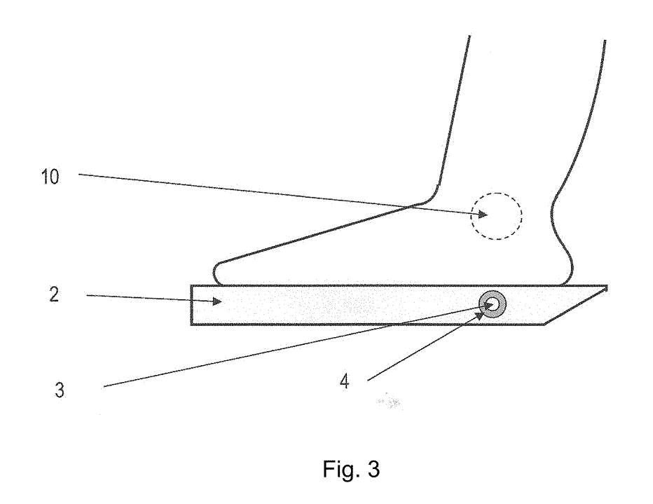

FIG. 3 is a layout of arrangement of the pedal opposite to the ankle.

### EMBODIMENT

The inventive device for plantar and dorsal flexions is shown on the attached FIG. 1 where pedals 2 arranged on the sides of the drive housing 1 on the shaft 4 oscillate around the axis 3. The drive housing 1 contains the drive mechanism, in particular an electric motor to drive the pedals 2. The drive housing 1 is provided with a lid 5. For easy operation the inventive device is provided on its front side with a switch 6, in particular on the drive housing 1 to supply the kinetic mechanism with the electric current. The switch is preferably located so that the current supply can be operated by legs without the need to bend down under the table. A remote control is part of the inventive design, which can be placed within the reach of the user, e.g. on the desk. A remote control is preferably adapted for connection with a computer, e.g. by USB port in order to control the device directly from the computer the user is working at. After switching on the power supply using the switch 6 on the drive housing 2 the remote control controls activity of the inventive device, mainly the beginning and the end of operation, the length of activity and frequency of plantar and dorsal flections.

According to FIG. 2 the drive mechanism 7 consists of one tow bar connected at one end with the eccentric and at the other end with the end of the other tow bar connected with the shaft 4.

According to FIG. 3 the foot with the ankle 10 is placed on the pedal 2 oscillating around the shaft 4 with the axis 3. The pedal 2 swinging axis 3 is arranged under the pedal adjacently to a perpendicular projection of the ankle 10 to the pedal 2.

1-5. (canceled)

6. Device for passive therapeutic exercise, especially for plantar and dorsal flexions of lower limbs, comprising at least one pedal for swivelling motion of a foot, the pedal pivotally mounted on a shaft, wherein the pedal (2) is arranged on the side of a drive housing (1) on a revolving shaft (4) extending from a side wall of the drive housing (1), the rotating shaft (4) coupled with a drive mechanism (7) arranged in the drive housing (1) to create a forced swinging movement of the pedal (2) around the axis (3) of the shaft (4), whereas the axis (3) of swinging of the pedal (2) is arranged under the pedal (2) adjacently to the perpendicular projection of the ankle joint (10) to the pedal (2).

7. The device according to the claim 6, wherein the drive housing (1) is provided with outriggers (8) for adjusting the inclination of the drive housing (1) towards the base (9).

8. The device according to claim 6, wherein it includes a mechanism for switching the operations on and off and regulating the size of the range and speed of rocking the pedals.

9. The device according to claim 7, wherein it includes a mechanism for switching the operations on and off and regulating the size of the range and speed of rocking the pedals.
